(19) United States
(12) Patent Application Publication
(10) Pub. No.: US 2005/0226131 A1
(43) Pub. Date: Oct. 13, 2005

(54) Optical recording medium, and manufacturing method and manufacturing device thereof

(76) Inventors: Tomoki Ushida, Tokyo (JP); Mamoru Usami, Tokyo (JP); Tsuyoshi Komaki, Tokyo (JP)

Correspondence Address: OLIFF & BERRIDGE, PLC, P.O. BOX 19928, ALEXANDRIA, VA, 22320, US

(21) Appl. No.: 10/519,543

(22) PCT Filed: Jun. 6, 2003
(86) PCT No.: PCT/JP03/07236

§ 371 Date: Dec. 28, 2004

(30) Foreign Application Priority Data
Jul. 1, 2002 (JP) 2002-192331

(51) Int. Cl. G11B 7/24

(52) U.S. Cl. 369/275.1

(57) ABSTRACT

An optical recording medium including a light transmitting resin layer which is hardly susceptible to flaws and stripping and is formed with high accuracy, and a manufacturing method and a manufacturing device of the optical recording medium are provided.

An optical recording medium 10 includes: a disc-like shaped support substrate 12 having an information recording face 12A on one side; and a light transmitting resin layer 14 formed on the information recording face 12A of the support substrate 12. An annular convex portion 16 projecting in a thickness direction so as to surround a center axis line 12B of the support substrate 12 is formed on the resin layer 14, and the resin layer 14 is extended to the inside of the annular convex portion 16 in a radial direction.

### TECHNICAL FIELD

The present invention relates to an optical recording medium including a light transmitting resin layer formed on a support substrate on the side of an information recording face, and a manufacturing method and a manufacturing device of the optical recording medium.

### BACKGROUND ART

Recently, optical recording media such as a CD (Compact Disc) and a DVD (Digital Versatile Disc) are rapidly spreading as information recording media. The optical recording media generally have an outer diameter of 120 mm and a thickness of 1.2 mm. In the case of the DVD, a laser beam having a shorter wavelength than that for the CD is used as irradiation light. In addition, a numerical aperture of a lens for the irradiation light is set larger than that of the CD. As a result, the DVD is capable of recording and reproducing a larger amount of information at a higher density than the CD.

On the other hand, information recording and reproduction accuracy is more likely to lower as the wavelength of irradiation light becomes shorter and the numerical aperture of a lens becomes larger because coma aberration occurs due to inclination (warp) of a disc. Thus, the DVD includes a light-transmitting resin layer having a half thickness of that of the CD, that is, 0.6 mm so as to ensure a margin for the inclination (warp) of the disc to keep the information recording/reproduction accuracy.

Since the resin layer at a thickness of 0.6 mm alone does not offer sufficient stiffness and strength, the DVD has such a structure that a pair of resin substrates, each having a thickness of 0.6 mm, are bonded to each other so that the information recording faces inside. As a result, the DVD has a thickness of 1.2 mm, which is equal to that of the CD, to ensure the same stiffness and strength as those of the CD.

Moreover, a center hole is generally formed through the optical recording medium, for positioning or the like in a recording and reproduction device or the like.

In recent years, in order to realize the recording of a larger amount of information at a higher density, there is a request for further reduction of the wavelength of irradiation light and further increase of the numerical aperture of a lens. In response to the request, an optical recording medium including a resin layer at a further reduced thickness is needed. Moreover, in order to standardize the specifications, it has been suggested to use a blue-violet laser beam having a wavelength of 405 nm as irradiation light and a numerical aperture of 0.85 and correspondingly to set a thickness of the resin layer to 0.1 mm.

By the way, during the use of the optical recording medium, the resin layer is flawed or dusts adhere thereto in some case. For example, it happens that a plurality of optical recording media are piled up so as to allow for compact storage of the optical recording media. However, the resin layer is sometimes flawed through a contact with another optical recording medium. As a result, information on the optical recording medium cannot be precisely reproduced or information cannot be precisely recorded on the optical recording medium in some cases. In the case of a thin resin layer having a thickness of about 0.1 mm, there is a problem that it is particularly susceptible to flaws, dusts or the like.

On the other hand, in Japanese Patent Laid-Open Publication No. 2002-63737 by the same applicant of the present invention, an optical recording medium, which is intended to solve the above problem by forming an inner periphery of a resin layer as an annular convex portion, is disclosed. Specifically, by forming the inner periphery of the resin layer as the annular convex portion, a contact pressure does not act on the resin layer because a gap is generated between the resin layer outside the annular convex portion and another optical recording medium even if a plurality of optical recording media are piled up. Even if the piled optical recording media are slightly inclined to come into contact with each other, the contact pressure is kept small. In this manner, the resin layer can be prevented from being flawed.

FIG. 11 is a sectional view showing a structure of an optical recording medium including an inner periphery of a resin layer, which is formed as an annular convex portion.

An optical recording medium 100 is of single-sided type capable of recording information only on one side. It has such a structure that a light transmitting resin layer 104 which is thinner than a support substrate 102 is formed on the support substrate 102 on the side of an information recording face 102A.

The support substrate 102 has a diameter of 120 mm and a thickness of 1.1 mm, and is generally formed by injection molding excellent in mass productivity. More specifically, after a resin such as polycarbonate is injected between a pair of molds, it is cooled and kept at a predetermined temperature. Then, it is formed in a disc-like shape having a center hole 102B.

The resin layer 104 has a thickness of 0.1 mm. An annular convex portion 106 is formed on its inner periphery. The resin layer 104 is formed on the support substrate 102 on the information recording face 102A side by spin coating. FIG. 12 is a sectional view showing a step of forming the resin layer 104 by spin coating.

First, the support substrate 102 is mounted on a rotating table 108 so that the center hole 102B is closed by a closing member 110. Next, the support substrate 102 is rotated with the rotating table 108 while a light transmitting radiation curable resin that can be cured by a radiation ray such as an ultraviolet ray or an electron beam is being supplied to the vicinity of the center of the closing member 110. The supplied resin is made to flow outward in a radial direction by centrifugal force so as to be spread over the entire surface of the information recording face 102A at a thickness of 0.1 mm. As a result, the optical recording medium 100 has a total thickness of 1.2 mm. In the case of dual-sided type capable of recording information on both sides of a support substrate, a thickness of the support substrate is set to 1.0 mm and a resin layer at a thickness of 0.1 mm is formed on each of the faces of the support substrate. Alternatively, two support substrates, each having a thickness of 0.5 mm and including a resin layer at a thickness of 0.1 mm formed thereon, may be prepared and bonded to each other. The above-cited Patent Publication mainly discloses two formation methods as a method of forming an annular convex portion.

According to the first method of forming an annular convex portion, after a resin is spread, the closing member 110 is brought up so as to be separated from the support substrate 102. As a result, the closing member 110 makes the resin in the surroundings protrude in a thickness direction in a trailing manner, thereby forming the annular convex portion 106.

In this case, after the formation of the annular convex portion 106, the annular convex portion 106 is irradiated with an ultraviolet ray, an electron beam or the like so as to be cured.

According to the second method of forming an annular convex portion, an area outside the closing member 110 in the radial direction is irradiated with an ultraviolet ray, an electron beam or the like while the resin is allowed to flow outward in the radial direction by centrifugal force with the closing member 110 being attached to the support substrate 102. In this manner, the resin is cured along the outer circumference of the closing member 110. By restricting a radial flow of the uncured resin in the vicinity of the outer circumference of the closing member 110, the resin is made to protrude in the thickness direction along the outer circumference of the closing member 110 to form the annular convex portion 106.

In the first method of forming an annular convex portion, however, the resin trails or the like when the closing member 110 is separated upward from the support substrate 102, resulting in degradation of the appearance of the inner periphery of the resin layer 104 in some cases.

On the other hand, in the second method of forming an annular convex portion, since the outer circumference of the closing member 110 is irradiated with an ultraviolet ray or the like while the closing member 110 is mounted on the support substrate 102, the resin around the closing member 110 is cured so that the closing member 110 is fixed to the support substrate 102. As a result, the closing member 110 cannot sometimes be easily separated from the support substrate 102. Furthermore, in this case, if the closing member 110 is forced to be separated from the support substrate 102, the inner periphery of the resin layer 104 gets chipped or the resin layer 104 is stripped away from the support substrate 102 in some cases.

Moreover, since the annular convex portion 106 frequently gets into contact with a component for positioning in an information recording device or an information reproduction device, a finger or the like because of its protruding shape. As a result, an external force acts on the inner periphery of the resin layer 104, so that the inner periphery of the resin layer 104 is sometimes stripped away from the support substrate 102 as shown in FIG. 13.

### DISCLOSURE OF THE INVENTION

In view of the foregoing problems, various exemplary embodiments of this invention provide an optical recording medium including a light transmitting resin layer that is hardly susceptible to flaws or stripping and is formed at high accuracy, and a manufacturing method and a manufacturing device of the optical recording medium.

In order to achieve the above object, as a result of a keen examination, the inventors of the present invention have found that a flaw or stripping of a resin layer hardly occurs and it is ensured that the resin layer can be formed at high accuracy by forming an annular convex portion projecting in the thickness direction along an inner circumference of the resin layer on the resin layer and extending the resin layer to the inside of the annular convex portion in the radial direction.

Specifically, the above object can be achieved by the following various exemplary embodiments of the present invention.

(1) An optical recording medium comprising:

a disc-like shaped support substrate including an information recording face at least on one side; and

a light transmitting resin layer formed on the support substrate on the information recording face side, wherein

an annular convex portion projecting in a thickness direction so as to surround a center axis line of the support substrate is formed on the resin layer, and the resin layer is extended to inside of the annular convex portion in a radial direction.

(2) The optical recording medium according to (1) wherein

the annular convex portion is integrally formed with the resin layer.

(3) A method for manufacturing an optical recording medium, comprising:

a spreading step of approximately horizontally placing a disc-like shaped support substrate including an information recording face at least on one side so that the information recording face is oriented upward and supplying a light transmitting radiation curable resin having in a flowing state to the vicinity of a center of the information recording face while rotationally driving the support substrate, thereby allowing the radiation curable resin to flow outward in a radial direction by centrifugal force so as to be spread on the information recording face;

a first curing step of radiating a radiation ray exclusively to an outer area outside a predetermined concentric inner area on the information recording area in the radial direction while the support substrate is being rotated to increase its viscosity and cure the extended radiation curable resin, and restricting a radial flow of the radiation curable resin in an uncured state within the inner area in the vicinity of an outer circumference of the inner area so as to allow the radiation curable resin to flow and project in a thickness direction along the outer circumference of the inner area to cure the radiation curable resin, thereby integrally forming an outer part of the light transmitting resin layer and an annular convex portion; and

a second curing step of radiating a radiation ray at least to the inner area so as to cure the radiation curable resin in an uncured state within the inner area, thereby integrally forming an inner part inside the annular convex portion in the radial direction as a part of the resin layer with the annular convex portion and the outer part.

(4) A method for manufacturing an optical recording medium, comprising:

a spreading step of approximately horizontally placing a disc-like shaped support substrate including an information recording face at least on one side so that the information recording face is oriented upward and supplying a light transmitting radiation curable resin in a flowing state to the vicinity of a center of the information recording face while rotating the support substrate, thereby allowing the radiation curable resin to flow outward in a radial direction by centrifugal force so as to be spread on the information recording face;

a first curing step of radiating a radiation ray exclusively to an outer area, outside a predetermined concentric inner area on the information recording face in the radial direction in any one of a state where the support substrate is stopped rotating and a state where the support substrate is rotated in a lower speed of revolution than that at the spreading step so as to cure the extended radiation curable resin, thereby forming an outer part of a light transmitting resin layer;

a second curing step of radiating a radiation ray exclusively to the outer area while the support substrate is being rotated and at least to an area in the vicinity of an outer circumference of the inner area so as to restrict a radial flow of the radiation curable resin in an uncured state within the inner area in the vicinity of the outer circumference of the inner area so as to allow the radiation curable resin to flow and project in a thickness direction along the outer circumference of the inner area and cure the radiation curable resin, thereby forming an annular convex portion integrally with an outer part of the resin layer; and

a third curing step of radiating a radiation ray at least to the inner area so as to cure the radiation curable resin in an uncured state within the inner area, thereby integrally forming an inner part inside the annular convex portion in the radial direction as a part of the resin layer with the annular convex portion and the outer part.

(5). A method for manufacturing an optical recording medium, comprising:

a spreading step of approximately horizontally placing a disc-like shaped support substrate including an information recording face at least on one side so that the information recording face is oriented upward and supplying a light transmitting radiation curable resin in a flowing state to the vicinity of a center of the information recording face while rotating the support substrate, thereby allowing the radiation curable resin to flow outward in a radial direction by centrifugal force so as to be spread on the information recording face;

a first curing step of radiating a radiation ray to a predetermined concentric inner area on the information recording face and an outer area outside the inner area in the radial direction so as to cure the extended radiation curable resin, thereby forming a light transmitting resin layer;

an annular convex portion formation step of discharging a radiation curable resin in an annular manner along an outer circumference of the inner area to form an annular convex portion on the resin layer; and

a second curing step of radiating a radiation ray at least along the outer circumference of the inner area to cure the annular convex portion.

(6) A manufacturing device of an optical recording medium, comprising:

rotation device for rotating a disc-like shaped support substrate including an information recording face at least on one side while approximately horizontally supporting the support substrate so that the information recording face is oriented upward;

radiation curable resin supply device for supplying a light transmitting radiation curable resin in a flowing state to the vicinity of a center of the information recording face of the support substrate; and

irradiation device capable of radiating a radiation ray to a predetermined concentric inner area on the information recording face and of radiating the radiation ray exclusively to an outer area outside the inner area in a radial direction.

(7) The optical recording medium according to (1) or (2), wherein

the resin layer is formed so that a thickness of an inner part inside the annular convex portion in the radial direction is smaller than that of an outer part outside the annular convex portion in the radial direction.

(8) The optical recording medium according to (1), (2 ) or (7), wherein

the resin layer is formed so that a thickness of an inner part inside the annular convex portion in the radial direction becomes smaller toward inside in the radial direction.

(9) The optical recording medium according to (1), (2), (7) or (8), wherein

the annular convex portion is formed in a circular ring shape concentric with the support substrate.

(10) The optical recording medium according to (1), (2), (7), (8) or (9), wherein

the annular convex portion is formed intermittently in a circumferential direction.

(11) The optical recording medium according to (1), (2), (7), (8), (9) or (10) wherein

the support substrate has a stepwise shape with a step on the information recording face along the annular convex portion.

(12) The optical recording medium according to (3) or (4), wherein

the support substrate has a stepwise shape with a step on the information recording face along the annular convex portion.

(13) The optical recording medium according to (3), (4) or (12), wherein

the support substrate has a stepwise shape with a step on the information recording face along the annular convex portion.

The term “radiation ray” generally means electromagnetic waves and particle beams such as a γ-ray, an X-ray, and an α-ray, which are released with the decay of a radioactive element. Throughout this specification, however, the term “radiation ray” is used to generically mean electromagnetic waves and particles beams, for example, an ultraviolet ray, an electron beam or the like, which have a property of curing a specific resin in a flowing state.

### BRIEF DESCRIPTION OF THE DRAWINGS

FIG. 1 is a sectional view showing a structure of an optical recording medium according to a first exemplary embodiment of the present invention;

FIG. 2 is a sectional view showing a part of a manufacturing device for forming a resin layer of the optical recording medium;

FIG. 3 is a sectional view showing how the manufacturing device is used;

FIG. 4 is a sectional view showing a step of spreading the resin layer of the optical recording medium according to the first exemplary embodiment of the present invention;

FIG. 5 is a sectional view showing a first curing step of the resin layer;

FIG. 6 is a sectional view showing a second curing step of the resin layer;

FIG. 7 is a sectional view showing a first curing step of a resin layer of an optical recording medium according to a second exemplary embodiment of the present invention;

FIG. 8 is a sectional view showing a second curing step of the resin layer;

FIG. 9 is a sectional view showing a third curing step of the resin layer;

FIG. 10 is a sectional view showing a structure around an inner part of a resin layer in an optical recording medium according to another exemplary embodiment of the present invention in an enlarged manner;

FIG. 11 is a sectional view showing a structure of a conventional optical recording medium;

FIG. 12 is a sectional view showing a manufacturing step of the conventional optical recording medium; and

FIG. 13 is a sectional view showing the stripping of an inner part of a resin layer in the conventional optical recording medium.

### BEST MODE FOR CARRYING OUT THE INVENTION

Various exemplary embodiments of this invention will be hereinafter described in detail with reference to the drawings.

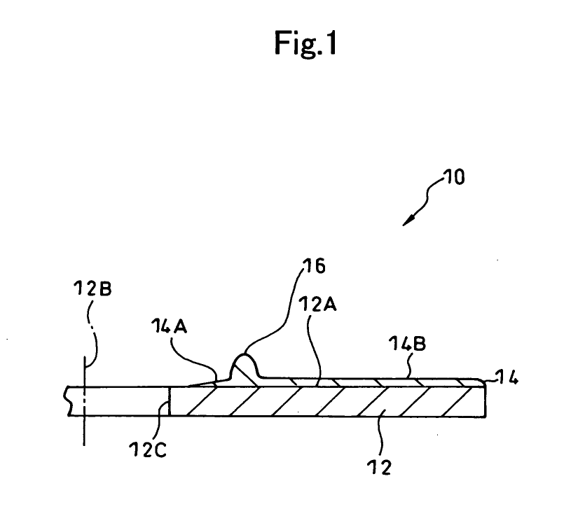

FIG. 1 is a sectional view of an optical recording medium 10 according to this exemplary embodiment.

An optical recording medium 10 is characterized as follows. It includes: a disc-like shaped support substrate 12 having an information recording face 12A on one side; and a light transmitting resin layer 14 formed on the information recording face 12A of the support substrate 12. An annular convex portion 16 is formed on the resin layer 14 so as to protrude in a thickness direction and surround a center axis line 12B of the support substrate 12. At the same time, the resin layer 14 is formed to extend to the inside of the annular convex portion 16 in the radial direction.

Since the other structure is the same as that of the conventional optical recording medium 100 described above, the description thereof is appropriately omitted.

The support substrate 12 has a center hole 12C. Predetermined fine concavity and convexity and the like (the illustration herein omitted) are formed on the information recording face 12A. The support substrate 12 is made of a resin such as polycarbonate, acrylic or epoxy, and has a diameter of 120 mm and a thickness of 1.1 mm.

A predetermined functional layer is formed on the information recording face 12A. Since the functional layer is thinner than the resin layer 14 and is not considered to be particularly necessary for understanding of the present invention, the illustration of the functional layer is herein omitted. If the optical recording medium 10 is of read only type, a reflective layer is formed on the information recording face 12A as a functional layer. On the other hand, the optical recoding medium 10 is of information writable and readable type, a reflective layer and a recording layer are formed on the information recording face 12A in this order as functional layers. The reflective layer is made of Al, Ag, Au, or the like, and is formed by sputtering, vapor deposition or the like. The recording layer is made of a phase-change material, a coloring material, a photomagnetic material or the like, and is formed by sputtering, spin coating, dipping, vapor deposition, or the like.

The resin layer 14 includes: an inner part 14A inside the annular convex portion 16 in a radial direction; and an outer part 14B outside the annular convex portion 16 in the radial direction. The inner part 14A is formed inside an information recording area (the illustration herein omitted) of the information recording face 12A in the radial direction, whereas the outer part 14B is formed in a region including the information recording area. The outer part 14B is irradiated with irradiation light for recording and reproducing information, and has a thickness of 0.1 mm.

The inner part 14A and the annular convex portion 16 are made of the same light transmitting resin as that of the outer part 14B. However, the inner part 14A and the annular convex portion 16 are not irradiated with irradiation light for recording and reproducing information.

The resin layer 14 is formed so that a thickness of the inner part 14A is smaller than that of the outer part 14B. The inner part 14A is formed to have a thickness gradually decreasing toward the inside in the radial direction.

The annular convex portion 16 has a circular ring shape approximately concentric with the support substrate 12 so as to be integrally formed with the resin layer 14. The annular convex portion 16 is formed inside of the information recording area (the illustration herein omitted) of the information recording face 12A in the radial direction. The annular convex portion 16 is more specifically formed so that the amount of projection is about 0.03 to 0.3 mm and a radial width is about 0.3 to 3 mm.

Since the annular convex portion 16 is formed on the resin layer 14 in this manner, a gap is generated between the outer part 14B of the resin layer 14 and another optical recording medium or the like when a plurality of optical recording media 10 are piled up for storage or the optical recording medium 10 is placed on a table or the like. As a result, a contact pressure does not act on the outer part 14B. Even if the optical recording medium 10 is inclined so that another optical recording medium or the like comes into contact with the outer part 14B, the contact pressure can be kept small to prevent the outer part 14B from being flawed. Specifically, the optical recording medium 10 has high reliability in information recording and reproduction.

When a finger or the like touches the annular convex portion 16 to exert an external force on the annular convex portion 16, a force of separating the inner part 14A of the resin layer 14 from the support substrate 12 may act on the inner part 14A. However, since the inner part 14A is a thin layer with small bending stiffness, it is likely to absorb the deformation of the annular convex portion 16. Thus, the force of separation from the support substrate 12 mainly acts in a plane direction, while a force in the thickness direction is kept small.

In particular, since the inner part 14A has a smaller thickness than that of the outer part 14B and, in addition, is formed to decrease its thickness toward the inside in the radial direction, the inner part 14A is correspondingly likely to absorb the deformation of the annular convex portion 16. As a result, the force in the thickness direction of separating the inner part 14A from the support substrate 12 is kept small.

Moreover, since the inner part 14A has a certain width in the radial direction, the force of separating it from the support substrate 12 is dispersed in the radial direction, keeping a force per unit area correspondingly small. Therefore, the inner part 14A is not easily stripped away from the support substrate 12.

In addition, since the inner part 14A has a thickness smaller than that of the outer part 14B and is also formed to decrease its thickness toward the inside in the radial direction, a finger or the like is unlikely to come into direct contact with the inner periphery of the inner part 14A. Also in this regard, the inner part 14A is hardly stripped away from the support substrate 12.

Specifically, in the case where the annular convex portion constitutes the inner periphery of the resin layer, when an external force acts on the annular convex portion, a force in the thickness direction of separating from the support substrate acts on the inner periphery of the resin layer in a concentrated manner. Therefore, the resin layer is likely to be stripped away from the inner periphery. By forming the inner part 14A inside of the annular convex portion 16 in the radial direction, however, the force in the thickness direction of separating the inner part 14A from the support substrate 12 is kept small. As a result, the resin layer 14 is not easily stripped away from the support substrate 12 in the inner part 14A.

On the other hand, the outer part 14B of the resin layer 14 is also a thin layer. In addition, it is extended so as to be longer from the annular convex portion 16 than the inner part 14A in the radial direction to stick to the support substrate 12 on a larger area than the inner part 14A. Accordingly, the outer part 14B is more unlikely to be stripped away from the support substrate 12 than the inner part 14A.

Specifically, the resin layer 14 is not easily stripped away from the support substrate 12 in any of the inner part 14A and the outer part 14B, providing reliability in durability.

Moreover, since the annular convex portion 16 is integrally formed with the resin layer 14, a rupture between the annular convex portion 16 and the resin layer 14 hardly occurs.

Next, a method for manufacturing the optical recording medium 10 will be described.

The method for manufacturing the optical recording medium 10 has a characteristic in a step of forming the resin layer 14 and the annular convex portion 16. Since the other steps are the same as those of the manufacturing method of the conventional optical recording medium 100, the description thereof is appropriately herein omitted.

First, a spreading step of spreading the resin layer 14 on the support substrate 12 will be described.

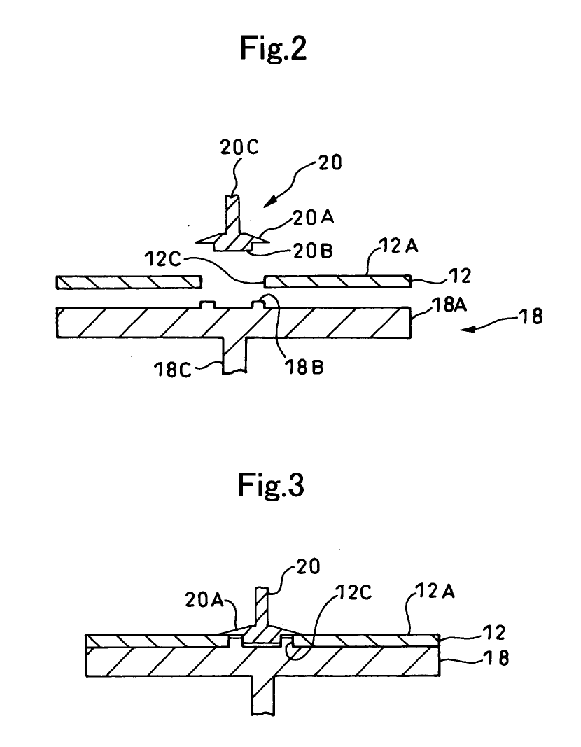

FIG. 2 is a sectional view showing the structures of the rotating table (rotary driving device) 18 for rotationally driving the support substrate 12 while it is kept horizontal and the closing member 20 for closing the center hole 12C through the support substrate 12 on the information recording face 12A side.

The rotating table 18 has an annular projection 18B provided concentric on the upper face of a disc-like shaped main body 18A which is approximately horizontally placed. The outer circumference of the annular projection 18B is fitted into the center hole 12C of the support substrate 12, so that the support substrate 12 can be kept horizontal and concentric. A rotating shaft 18C is provided on the bottom face side of the main body 18A.

The closing member 20 has a closing part 20A of which an upper face is inclined downward in an outer radial direction and its outer diameter is slightly larger than that of the center hole 12C of the support substrate 12. On the bottom face side of the closing part 20A, a circular projection 20B, which projects downward, is provided concentric. The outer circumference of the circular projection 20B is fitted into the inner circumference of the annular projection 18B of the rotating table 18, while the center hole 12C of the support substrate 12 can be closed by the closing part 20A. The outer diameter of the closing part 20A is smaller than the inner diameter of the annular projecting portion 16 to be formed. Furthermore, on the upper face side of the closing part 20A, a longitudinal bar-shaped support portion 20C is provided so as to be longitudinally driven through the support portion 20C to be freely fitted into and removed from the rotating table 18.

First, as shown in FIG. 3, the support substrate 12 is mounted onto the rotating table 18 so that the information recording face 12A is oriented upward. Then, the closing member 20 is brought down to fit the circular projection 20B into the annular projection 18B of the rotating table 18 while closing the center hole 12C of the support substrate 12 by the closing part 20A.

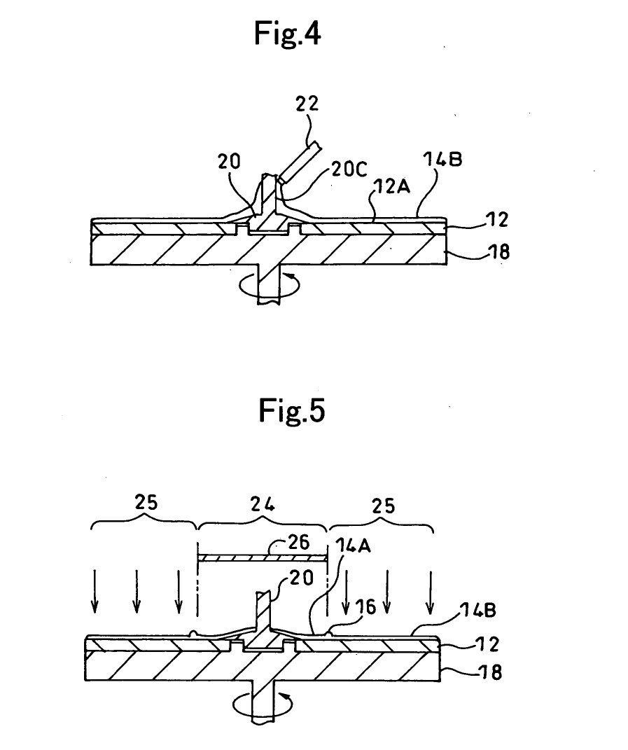

Next, as shown in FIG. 4, a nozzle (radiation curable resin supply device) 22 is brought closer to the support part 20C of the closing member 20 so as to supply a predetermined amount of a light transmitting ultraviolet curable resin in a flowing state onto the closing member 20. At the same time, the support substrate 12 is rotated by the rotating table 18 to allow the ultraviolet curable resin to flow outward in the radial direction by centrifugal force, thereby spreading the ultraviolet curable resin on the information recording face 12A. At this time, since the centrifugal force scarcely acts on the resin in the vicinity of the center of rotation, the center part of the closing member 20 serves as a resin reservoir to buffer the amount of the resin flowing on the information recording face 12A to stabilize it. As a result, the resin is spread on the entire information recording face 12A at a uniform thickness of about 0.1 mm.

Next, a first curing step will be described. The first curing step is for curing the outer part 14B of the resin layer 14 as well as for allowing the ultraviolet curable resin to project in an annular manner to form the annular convex portion 16. Specifically, the support substrate 12 is rotated. An outer area 25, which is situated radially outside a concentric circular-shaped inner area 24 on the information recording face 12A, is exclusively irradiated with an ultraviolet ray by an irradiation device not shown so as to increase its viscosity and cure the spread ultraviolet curable resin. An outer diameter of the inner area 24 is set so as to be equal to the inner diameter of the annular convex portion 16 to be formed. Since the outer area 25 is exclusively irradiated with an ultraviolet ray, a shielding mask 26 having an outer diameter equal to that of the inner area 24 is concentrically located above the information recording face 12A to shield the inner area 24 as shown in FIG. 5.

As a result, the outer part 14B of the resin layer 14 is cured. At the same time, a radial flow of the uncured ultraviolet curable resin in the inner area 24 is restricted in the vicinity of the outer circumference of the inner area 24 so that the uncured ultraviolet curable resin flows and projects in the thickness direction and is cured. Then, the annular convex portion 16 is formed along the outer circumference of the inner area 24. The annular convex portion 16 is normally formed outside the outer circumference of the inner area 24. The annular convex portion 16 is sometimes formed on the outer circumference of the inner area 24 or inside the outer circumference in the radial direction, depending on formation conditions such as a speed of rotation of the support substrate 12, irradiation time of an ultraviolet ray, the amount of irradiation per unit time, and a viscosity of the ultraviolet curable resin. In order to form the annular convex portion at a desired position, the formation conditions and the setting of the inner area may be appropriately adjusted.

On the other hand, since the ultraviolet curable resin between the annular convex portion 16 and the closing member 20 is uncured, a flow of the ultraviolet curable resin is restricted by the annular convex portion 16 while the ultraviolet curable resin is flowing outward in the radial direction because of centrifugal force. As a result, the ultraviolet curable resin is formed in a layer that decreases its thickness toward the inside in the radial direction. The ultraviolet curable resin between the annular convex portion 16 and the closing member 20 forms the inner part 14A of the resin layer 14.

By regulating the rotation time of the support substrate 12, the amount of projection of the annular convex portion 16 and a thickness of the inner part 14A can be regulated. Specifically, as the rotation time of the support substrate 12 becomes longer, the amount of projection of the annular convex portion 16 increases because a corresponding amount of an uncured resin is added to the annular convex portion 16. At the same time, the uncured resin remaining as the inner part 14A is reduced to thin the inner part 14A. On the other hand, as the rotation time of the support substrate 12 becomes shorter, the amount of projection of the annular convex portion 16 becomes smaller and the inner part 14A becomes thicker. In this exemplary embodiment, the rotation time of the support substrate 12 is regulated so that the inner part 14A becomes thinner than the outer part 14B.

Next, the closing member 20 is brought up so as to be separated from the support substrate 12. Since the surroundings of the closing member 20 are not irradiated with an ultraviolet ray and therefore a resin (the inner part 14A) in the surroundings of the closing member 20 remains uncured, the closing member 20 can be easily separated from the support substrate 12. Moreover, since the inner part 14A is a thin layer, the resin in the surroundings of the closing member 20 does not trail or the like when the closing member 20 is separated from the support substrate 12. Specifically, the inner part 14A of the resin layer 14 can be formed with high accuracy.

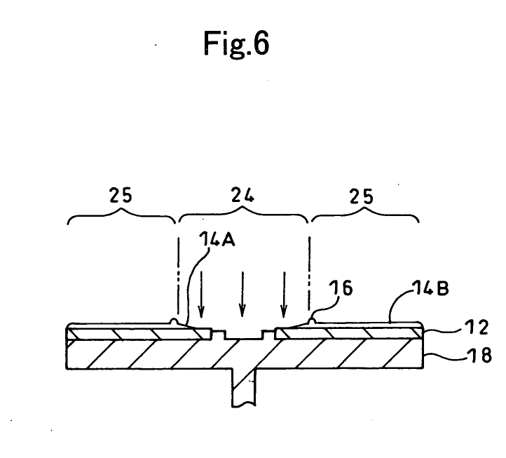

Next, a second curing step will be described. The second curing step is for curing the inner part 14A of the resin layer 14. Specifically, the shielding mask 26 above the information recording face 12A is removed. Then, as shown in FIG. 6, the inner area 24 is irradiated with an ultraviolet ray to cure the inner part 14A. At this time, the outer area 25 may also be irradiated with an ultraviolet ray.

As a result, the inner part 14A and the outer part 14B of the resin layer 14 and the annular convex portion 16 are integrated with each other to complete the optical recording medium 10.

As described above, the ultraviolet curable resin is spread on the support substrate 12 and then is irradiated with an ultraviolet ray in two steps while limiting an irradiated area. In addition, by using centrifugal force, the annular convex portion 16 and the resin layer 14 can be integrally formed on the support substrate 12 in an easy manner. Therefore, the manufacturing method of an optical recording medium according to this exemplary embodiment has good production efficiency at low cost. In addition, since the ultraviolet curable resin does not trail or the like as described above when the closing member 20 is separated from the support substrate 12, the manufacturing method of the optical recording medium according to this exemplary embodiment has good formation accuracy for the resin layer.

A second exemplary embodiment of the present invention will now be described.

The outer part 14B of the resin layer 14 is cured while the support substrate 12 is being rotated in the first exemplary embodiment described above. On the other hand, this second exemplary embodiment is characterized in that an ultraviolet ray is radiated to the outer part 14B so as to cure the outer part 14B while the support substrate 12 is stopped rotating (or is being rotated at low speed).

Moreover, the outer part 14B of the resin layer 14 and the annular convex portion 16 are integrally formed at the first curing step in the first exemplary embodiment described above. On the other hand, this second exemplary embodiment is characterized in that only the outer part 14B of the resin layer 14 is formed at the first curing step and then the annular convex portion 16 is integrally formed with the outer part 14B at the second curing step.

Since the other steps are the same as those in the first exemplary embodiment described above, the description thereof is herein appropriately omitted. Furthermore, since the structure of an optical recording medium to be manufactured is similar to that of the optical recoding medium 10 of the first exemplary embodiment described above, the description thereof is herein omitted.

First, the first curing step of this second exemplary embodiment will be described. As in the first exemplary embodiment, an ultraviolet curable resin is spread on the information recording face 12A of the support substrate 12 at the spreading step prior to the first curing step (see FIG. 4).

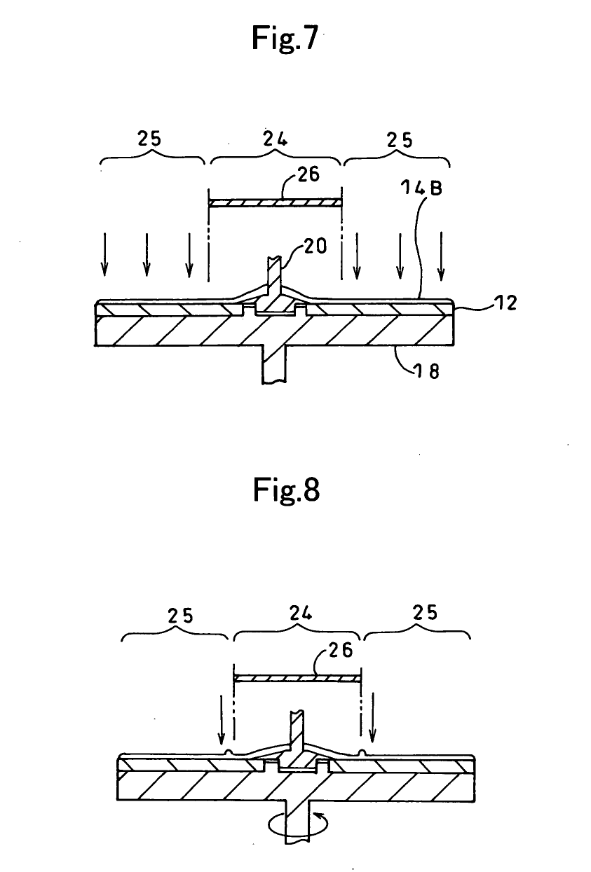

At the first curing step in this second exemplary embodiment, the outer area 25 is exclusively irradiated with an ultraviolet ray so as to cure the ultraviolet curable resin while the rotation of the support substrate 12 is stopped as shown in FIG. 7. In this manner, the outer part 14B of the resin layer 14 is formed. Alternatively, the outer part 14B of the resin layer 14 may be formed by radiating an ultraviolet ray exclusively to the outer area 25 so as to cure the ultraviolet curable resin while the support substrate 12 is rotated in lower speed of revolution than that at the spreading step described above.

By stopping the rotation of the support substrate 12 (or rotating it at low speed), the ultraviolet curable resin on the information recording face 12A does not flow (or its flow is kept to be extremely small) to stabilize its form. The outer part 14B is cured while its thickness is correspondingly kept uniform. Specifically, the outer part 14B can be formed with high accuracy. Even if the support substrate 12 is rotated at the following steps, the resin does not flow in the outer part 14B to allow a uniform thickness to be kept.

Next, the second curing step will be described. The second curing step is for allowing the ultraviolet curable resin to project in the thickness direction so as to form the annular convex portion 16 integrally with the outer part 14B of the resin layer 14. As shown in FIG. 8, the support substrate 12 is rotationally driven by the rotating table 18. The vicinity of the outer circumference of the inner area 24, which is within the outer area 25, is exclusively irradiated with an ultraviolet ray. A flow of an uncured ultraviolet curable resin in the inner area 24 in the vicinity of the outer circumference of the inner area 24 is restricted so that the ultraviolet curable resin is allowed to flow and project in the thickness direction along the outer circumference of the inner area 24 so as to be cured. At this time, not only the vicinity of the outer circumference of the inner area 24 but also the other part of the outer area 25 may be irradiated with an ultraviolet ray. As a result, the annular convex portion 16 is integrally formed with the outer part 14B of the resin layer 14. Although the annular convex portion 16 is generally formed outside the outer circumference of the inner area 24, the annular convex portion 16 is sometimes formed on the outer circumference of the inner area 24 or inside the outer circumference in the radial direction, depending on formation conditions such as a speed of rotation of the support substrate 12, irradiation time of an ultraviolet ray, the amount of irradiation per unit time, and a viscosity of the ultraviolet curable resin.

On the other hand, since the ultraviolet curable resin between the annular convex portion 16 and the closing member 20 remains uncured, a flow of the ultraviolet curable resin is restricted by the annular convex portion 16 while the ultraviolet curable resin is flowing outward in the radial direction because of centrifugal force. As a result, the ultraviolet curable resin is formed in a layer that decreases its thickness toward the inside in the radial direction. The ultraviolet curable resin between the annular convex portion 16 and the closing member 20 forms the inner part 14A of the resin layer 14.

Next, the closing member 20 is brought up so as to be separated from the support substrate 12. Since a resin (the inner part 14A) in the surroundings of the closing member 20 remains uncured, the closing member 20 can be easily separated from the support substrate 12. Since the inner part 14A is a thin layer, the resin in the surroundings of the closing member 20 does not trail or the like when the closing member 20 is separated away from the support substrate 12.

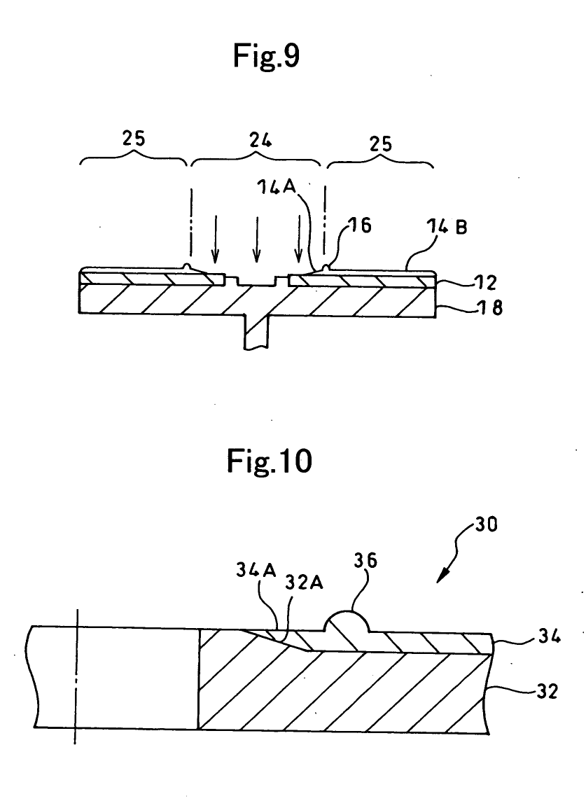

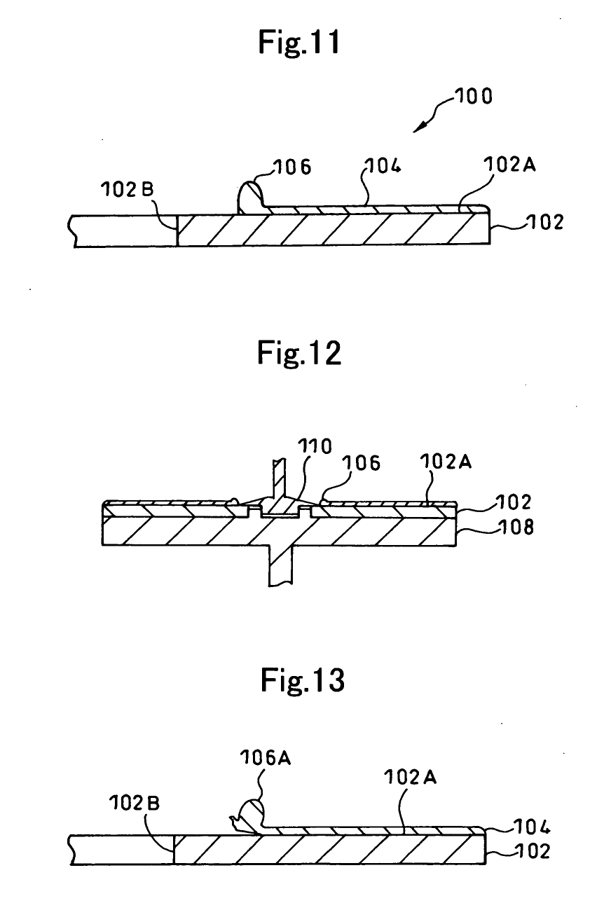

Next, a third curing step will be described. The third curing step is the same as the second curing step in the first exemplary embodiment described above. The shielding mask 26 above the information recording face 12A is removed. Then, as shown in FIG. 9, the inner area 24 is irradiated with an ultraviolet ray to cure the inner part 14A of the resin layer 14. At this time, the outer area 25 may also be irradiated with an ultraviolet ray.

As a result, the optical recording medium 10 is completed.

In this second exemplary embodiment, the ultraviolet curable resin is spread on the support substrate 12 and then is irradiated with an ultraviolet ray in three steps while limiting an irradiated area. In addition, by using centrifugal force, the annular convex portion 16 and the resin layer 14 can be integrally formed on the support substrate 12 in an easy manner. Therefore, as the first exemplary embodiment described above, this exemplary embodiment has good production efficiency at low cost.

In addition, as in the first exemplary embodiment described above, since the ultraviolet curable resin does not trail or the like when the closing member 20 is separated from the support substrate 12, the inner part 14A of the resin layer 14 has good formation accuracy.

Furthermore, since the outer part 14B is cured while the support substrate 12 is stopped rotating (or is being rotated at low speed), the formation accuracy of the outer part 14B is particularly good. Specifically, the optical recording medium with good information recording and reproduction accuracy can be manufactured.

In the first exemplary embodiment and second exemplary embodiment described above, the resin layer 14 is formed so that the inner part 14A is thinner than the outer part 14B. However, the present invention is not limited thereto. The thickness of the inner part 14A may be equal to that of the outer part 14B. The inner part 14A may also be formed thicker than the outer part 14B.

Also in such a case, the inner part 14A is a thin layer with low stiffness and has a certain width in the radial direction. Therefore, when an external force acts on the annular convex portion, the effects of keeping a force in the thickness direction of separating the inner part 14A from the support substrate 12 small can be obtained. As a result, the inner part 14A is not easily stripped away from the support substrate 12.

Although the inner part 14A of the resin layer 14 has such a shape that the thickness decreases toward the inside in the radial direction in the above described first and second exemplary embodiments, the present invention is not limited thereto. For example, the inner part of the resin layer may be cured while the rotation of the support substrate is stopped to form the inner part having a uniform thickness.

Although the shielding mask 26 is used so as to radiate an ultraviolet ray exclusively to the outer area of the information recording area 12A in the above first and second exemplary embodiments, the present invention is not limited thereto. Even without using the shielding mask, for example, by using ultraviolet ray irradiation device capable of radiating an ultraviolet ray in a ring shape, the outer area of the information recording area 12A may also exclusively be irradiated with an ultraviolet ray.

Although the resin layer 14 is made of an ultraviolet curable resin in the first and second exemplary embodiments, the present invention is not limited thereto. The resin layer may be made of a resin having a property of being cured by other radiation rays such as an electron beam, and the resin layer and the annular convex portion may be cured by irradiation device for radiating an electron beam or the like.

Although the resin is supplied only at the spreading step in the above first and second exemplary embodiments, the present invention is not limited thereto. The resin may be supplied again to the inner area 24 after the first curing step. In this way, the formation time of the annular convex portion can be reduced. In addition, a difference in thickness between the outer part 14B and the inner part 14A may be arbitrarily regulated. In this case, the resin to be supplied again may be different from the first supplied one.

In the first and second exemplary embodiments described above, the resin is allowed to flow outward in the radial direction by centrifugal force. At the same time, by restricting a radial outward flow of the resin in the vicinity of the outer circumference of the inner area, the resin is made to flow and project in the thickness direction to form the annular convex portion. However, the present invention is not limited thereto. After a flat resin layer is formed in the inner area and the outer area by spin coating and then is cured, the resin may be discharged onto the resin layer in a ring shape along the outer circumference of the inner area so as to form and cure the annular convex portion.

Also in this case, when an external force acts on the annular convex portion, a force in the thickness direction of separating the inner part from the support substrate is kept small, so that the inner part is not easily stripped away from the support substrate.

Since the flat resin layer is formed prior to the formation of the annular convex portion, the resin layer having a uniform thickness with good formation accuracy can be easily formed.

In this case, the resin may be intermittently discharged in a circumferential direction so as to form an intermittent annular convex portion. Even if the annular convex portion is intermittent, the effects of preventing a flaw on the resin layer can be obtained. At the same time, by forming the annular convex portion in an intermittent form, the amount of a resin can be reduced to lower the costs. Furthermore, in this case, the resin may also be discharged in a non-concentric manner so as to form a non-concentric annular convex portion.

Although the thickness of the support substrate 12 is constant in the above first and second exemplary embodiments, the present invention is not limited thereto. A stepwise support substrate having a step on the information recording face along the annular convex portion may be used. In this manner, a total thickness of the optical recording medium can be arbitrarily regulated outside the annular convex portion in the radial direction and inside the annular convex portion in the radial direction. For example, even if a thickness differs between the inner part and the outer part of the resin layer, a thickness of the entire optical recording medium outside the annular convex portion in the radial direction can be equal to that inside the annular convex portion in the radial direction.

Furthermore, as shown in FIG. 10, a support substrate 32 having such an inclined part 32A that a part corresponding to an inner part 34A of a resin layer 34 becomes thicker toward the inside in the radial direction may be used. In this manner, the thickness of the part corresponding to the inner part 34A of the resin layer 34 can be uniform as the entire optical recording medium 30.

In the case where the support substrate is flat and the inner part of the resin layer becomes thinner toward the inside in the radial direction, the optical recording medium as a whole also has such a shape that becomes thinner toward the inside in the radial direction. Therefore, when a spindle portion of a drive of an information recording device, an information reproduction device or the like is loaded with the optical recording medium, chucking in consideration of a variation in thickness is sometimes required. On the other hand, by uniformizing the thickness of the part corresponding to the inner part 34A of the resin layer 34 as the entire optical recording medium 30 as described above, the spindle portion of the device of the information recording medium or the like can be easily loaded with the optical recording medium 30.

Although the resin layer 14 is formed on the support substrate 12 having the center hole 12C in the above first and second exemplary embodiments, the present invention is not limited thereto. After a light transmitting resin layer and an annular convex portion are formed on a disc-like shaped support substrate without any center hole or a disc-like shaped support substrate having a through hole with a smaller diameter than that of the center hole, the center hole may be formed by punching out the center of the support substrate and the resin layer. In this case, even without using the closing member, the radiation curable resin can be supplied to the vicinity of the center of the information recording face of the support substrate. Accordingly, the spreading step and the curing steps of the resin layer can be facilitated.

Furthermore, even without punching out the center, an optical recording medium without any center hole can be used. Specifically, the present invention is characterized in that the resin layer extends toward the inside of the annular convex portion in the radial direction, and therefore is applicable even to an optical recording medium without any center hole. In this case, the inner part of the resin layer is not necessarily formed in a ring shape; the inner part may be formed in a disc-like shape.

Moreover, the optical recording medium 10 is described as a single-sided type capable of recording information only on either side in the first and second exemplary embodiments described above, the present invention is not limited thereto. It is apparent that the present invention is also applicable to a double-sided recording type optical recording medium capable of recording information on its both sides. In this case, the thickness of the support substrate is set to 1.0 mm, and a light-transmitting layer whose outer part has a thickness of 0.1 mm is formed on each side of the support substrate. As a result, an optical recording medium having a thickness of 1.2 mm can be obtained. Alternatively, two support substrates, each having a thickness of 0.5 mm and including a resin layer at a thickness of 0.1 mm formed thereon, may be prepared and bonded to each other. Furthermore, the present invention is also applicable to an optical recording medium including a plurality of recording layers formed on either one of or both the surfaces.

### INDUSTRIAL APPLICABILITY

As described above, according to the present invention, excellent effects of allowing a resin layer, which is hardly susceptible to flaws and stripping, to be formed on an optical recording medium at high accuracy can be provided.

1-23. (canceled)

24. An optical recording medium comprising:
a disc-like shaped support substrate including an information recording face at least on one side; and
a light transmitting resin layer formed on the support substrate on the information recording face side, wherein
an annular convex portion projecting in a thickness direction so as to surround a center axis line of the support substrate is formed on the resin layer, and the resin layer is extended to inside of the annular convex portion in a radial direction.

25. The optical recording medium according to claim 24, wherein
the annular convex portion is integrally formed with the resin layer.

26. The optical recording medium according to claim 24, wherein
the resin layer is formed so that a thickness of an inner part inside the annular convex portion in the radial direction is smaller than that of an outer part outside the annular convex portion in the radial direction.

27. The optical recording medium according to claim 24, wherein
the resin layer is formed so that a thickness of an inner part inside the annular convex portion in the radial direction becomes smaller toward inside in the radial direction.

28. The optical recording medium according to claim 25, wherein
the resin layer is formed so that a thickness of the inner part inside the annular convex portion in the radial direction becomes smaller toward inside in the radial direction.

29. The optical recording medium according to claim 24, wherein
the annular convex portion is formed in a circular ring shape concentric with the support substrate.

30. The optical recording medium according to claim 25, wherein
the annular convex portion is formed in a circular ring shape concentric with the support substrate.

31. The optical recording medium according to claim 24, wherein
the annular convex portion is formed intermittently in a circumferential direction.

32. The optical recording medium according to claim 25, wherein
the annular convex portion is formed intermittently in a circumferential direction.

33. The optical recording medium according to claim 24, wherein
the support substrate has a stepwise shape with a step on the information recording face along the annular convex portion.

34. The optical recording medium according to claim 25, wherein
the support substrate has a stepwise shape with a step on the information recording face along the annular convex portion.

35. A method for manufacturing an optical recording medium, comprising:
a spreading step of approximately horizontally placing a disc-like shaped support substrate including an information recording face at least on one side so that the information recording face is oriented upward and supplying a light transmitting radiation curable resin having in a flowing state to the vicinity of a center of the information recording face while rotationally driving the support substrate, thereby allowing the radiation curable resin to flow outward in a radial direction by centrifugal force so as to be spread on the information recording face;
a first curing step of radiating a radiation ray exclusively to an outer area outside a predetermined concentric inner area on the information recording area in the radial direction while the support substrate is being rotated to increase its viscosity and cure the extended radiation curable resin, and restricting a radial flow of the radiation curable resin in an uncured state within the inner area in the vicinity of an outer circumference of the inner area so as to allow the radiation curable resin to flow and project in a thickness direction along the outer circumference of the inner area to cure the radiation curable resin, thereby integrally forming an outer part of the light transmitting resin layer and an annular convex portion; and
a second curing step of radiating a radiation ray at least to the inner area so as to cure the radiation curable resin in an uncured state within the inner area, thereby integrally forming an inner part inside the annular convex portion in the radial direction as a part of the resin layer with the annular convex portion and the outer part.

36. A method for manufacturing an optical recording medium, comprising:
a spreading step of approximately horizontally placing a disc-like shaped support substrate including an information recording face at least on one side so that the information recording face is oriented upward and supplying a light transmitting radiation curable resin in a flowing state to the vicinity of a center of the information recording face while rotating the support substrate, thereby allowing the radiation curable resin to flow outward in a radial direction by centrifugal force so as to be spread on the information recording face;
a first curing step of radiating a radiation ray exclusively to an outer area outside a predetermined concentric inner area on the information recording face in the radial direction in any one of a state where the support substrate is stopped rotating and a state where the support substrate is rotated in a lower speed of revolution than that at the spreading step so as to cure the extended radiation curable resin, thereby forming an outer part of a light transmitting resin layer;
a second curing step of radiating a radiation ray exclusively to the outer area while the support substrate is being rotated and at least to an area in the vicinity of an outer circumference of the inner area so as to restrict a radial flow of the radiation curable resin in an uncured state within the inner area in the vicinity of the outer circumference of the inner area so as to allow the radiation curable resin to flow and project in a thickness direction along the outer circumference of the inner area and cure the radiation curable resin, thereby forming an annular convex portion integrally with an outer part of the resin layer; and
a third curing step of radiating a radiation ray at least to the inner area so as to cure the radiation curable resin in an uncured state within the inner area, thereby integrally forming an inner part inside the annular convex portion in the radial direction as a part of the resin layer with the annular convex portion and the outer part.

37. The method for manufacturing an optical recording medium according to claim 35, wherein
the inner area is shielded by a shielding mask so as to radiate the radiation ray exclusively to the outer area.

38. The method for manufacturing an optical recording medium according to claim 35, wherein
the radiation curable resin is supplied again to the inner area after the first curing step.

39. The method for manufacturing an optical recording medium according to claim 37, wherein
the radiation curable resin is supplied again to the inner area after the first curing step.

40. A method for manufacturing an optical recording medium, comprising:
a spreading step of approximately horizontally placing a disc-like shaped support substrate including an information recording face at least on one side so that the information recording face is oriented upward and supplying a light transmitting radiation curable resin in a flowing state to the vicinity of a center of the information recording face while rotating the support substrate, thereby allowing the radiation curable resin to flow outward in a radial direction by centrifugal force so as to be spread on the information recording face;
a first curing step of radiating a radiation ray to a predetermined concentric inner area on the information recording face and an outer area outside the inner area in the radial direction so as to cure the extended radiation curable resin, thereby forming a light transmitting resin layer;
an annular convex portion formation step of discharging a radiation curable resin in an annular manner along an outer circumference of the inner area to form an annular convex portion on the resin layer; and
a second curing step of radiating a radiation ray at least along the outer circumference of the inner area to cure the annular convex portion.

41. A manufacturing device of an optical recording medium, comprising:
rotation device for rotating a disc-like shaped support substrate including an information recording face at least on one side while approximately horizontally supporting the support substrate so that the information recording face is oriented upward;
radiation curable resin supply device for supplying a light transmitting radiation curable resin in a flowing state to the vicinity of a center of the information recording face of the support substrate; and
irradiation device capable of radiating a radiation ray to a predetermined concentric inner area on the information recording face and of radiating the radiation ray exclusively to an outer area outside the inner area in a radial direction.

42. The method for manufacturing an optical recording medium according to claim 36, wherein
the inner area is shielded by a shielding mask so as to radiate the radiation ray exclusively to the outer area.

43. The method for manufacturing an optical recording medium according to claim 36, wherein
the radiation curable resin is supplied again to the inner area after the first curing step.
